(19) United States
(12) Patent Application Publication
(10) Pub. No.: US 2010/0116297 A1
(43) Pub. Date: May 13, 2010

(54) SYSTEM AND METHOD FOR COMPONENT RECOVERY

(75) Inventors: John H. Vontell, Manchester, CT (US); Ronald W. Brush, Ringwood, NJ (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/266,819

(22) Filed: Nov. 7, 2008

(51) Int. Cl. B08B 3/08; B08B 3/00

(52) U.S. Cl. 134/26; 134/186; 134/157; 134/198; 134/103.1; 134/98.1

(57) ABSTRACT

A component recovery system, configured to refurbish components, includes a fluid feed tank, a refurbishment compartment having a fluid delivery element, a waste tank, fluid lines connecting the fluid feed tank to the fluid delivery element and the refurbishment compartment to the waste tank, and pumps for delivering fluid through the fluid lines. The component recovery system removes field contaminants, coatings and bonding compounds from components.

### STATEMENT OF GOVERNMENT INTEREST

The U.S. Government has a paid-up license in this invention and the right in limited circumstances to require the patent owner to license others on reasonable terms as provided for by the terms of Contract No. N00019-02-C-3003 awarded by the United States Navy.

### BACKGROUND

In the aeronautical, aerospace and other industries, the components used are frequently expensive. Due to the high cost of many components, component refurbishment processes are important to return expensive components to service. Refurbishment often includes the removal of field contaminants and coatings or bonding compounds so that new coatings or bonding compounds can be applied to the component.

Refurbishment is generally done by immersing the component in tanks with sufficient amounts of chemicals to clean and/or strip the undesired contaminants, coatings, and bonding compounds. Typically, multiple tanks are needed for the multiple chemicals used in the refurbishment process. Each chemical generally requires its own individual tank. The larger the component, the larger the tank needed and the larger the amounts of chemicals needed to effectively refurbish the component.

This type of refurbishment process offers several disadvantages. First, a high volume of chemicals is needed to provide an immersion tank in which the entire component can be immersed. Chemicals used in the refurbishment process are often expensive. The greater the amount of chemical needed, the greater the expense will be for the refurbishment process. Second, many of the chemicals used in the refurbishment process are hazardous to the environment. The proper waste disposal of chemicals used in the refurbishment process involves additional expenses. When large amounts of chemicals are used in the immersion tanks as described above, large expenses are incurred to properly dispose of the large amounts of chemicals. Also, because many of the chemicals are hazardous, workers involved in the refurbishment process are also required to take the appropriate health and safety precautions. These precautions may provide additional expense. Third, when multiple immersion tanks are used in the refurbishment process, a large area often needs to be reserved for the tanks. When large tanks and a great number of tanks are needed, the refurbishment system may occupy a great deal of space.

### SUMMARY

An exemplary embodiment of the present invention is a refurbishment system that includes at least one fluid feed tank, a refurbishment compartment, and at least one waste tank. A first fluid line connects the at least one fluid feed tank to the refurbishment compartment. A second fluid line connects the refurbishment compartment to the at least one waste tank.

A further exemplary embodiment of the present invention is a method for refurbishing a component. The method includes placing the component in a refurbishment compartment and delivering a first fluid to the refurbishment compartment. The method also includes removing the first fluid from the refurbishment compartment and delivering the first fluid to a first waste tank. The method further involves delivering a second fluid to the refurbishment compartment and removing the second fluid from the refurbishment compartment and delivering the second fluid to a second waste tank.

Another exemplary embodiment is a refurbishment system that includes at least one fluid feed tank, a refurbishment compartment having at least one fluid delivery element and a drain, and at least one waste tank. A fluid line connects the at least one fluid feed tank to the at least one fluid delivery element. The refurbishment system also includes a feed pump configured to deliver fluid through the fluid line. A recirculation line connects the refurbishment compartment drain to the at least one fluid delivery element and to the at least one waste tank. The refurbishment system also includes a waste pump configured to deliver fluid through the recirculation line.

### BRIEF DESCRIPTION OF THE DRAWINGS

FIG. 1 is a schematic illustration of one embodiment of an apparatus for component recovery.

FIG. 2A is a schematic illustration of a chemical application cycle.

FIG. 2B is a schematic illustration of a chemical recirculation cycle.

FIG. 2C is a schematic illustration of a chemical waste collection cycle.

FIG. 2D is a schematic illustration of a chemical rinse and collection cycle.

FIG. 3A is a schematic illustration of one embodiment of an apparatus for component recovery with a basket during a chemical application cycle.

FIG. 3B is a schematic illustration of one embodiment of an apparatus for component recovery with a cage during a chemical application cycle.

### DETAILED DESCRIPTION

Coated components are used in a variety of industries. Components may be coated with silicone coatings, polymers and other coatings. These coatings may serve different purposes such as protecting the component surface from damage or providing better surface chemistry for bonding. The components coated may be made of different materials. Metal components as well as composite components may have coatings. The components themselves may be made of polymers that are different from the coatings. Often times, coated components are expensive to replace and component refurbishment is used to reduce costs. Chemical cleaning and stripping is used to refurbish a component so that new coatings may be applied and the component returned to service. The chemicals used in the refurbishment process will largely depend on the type of coating and the type of component material.

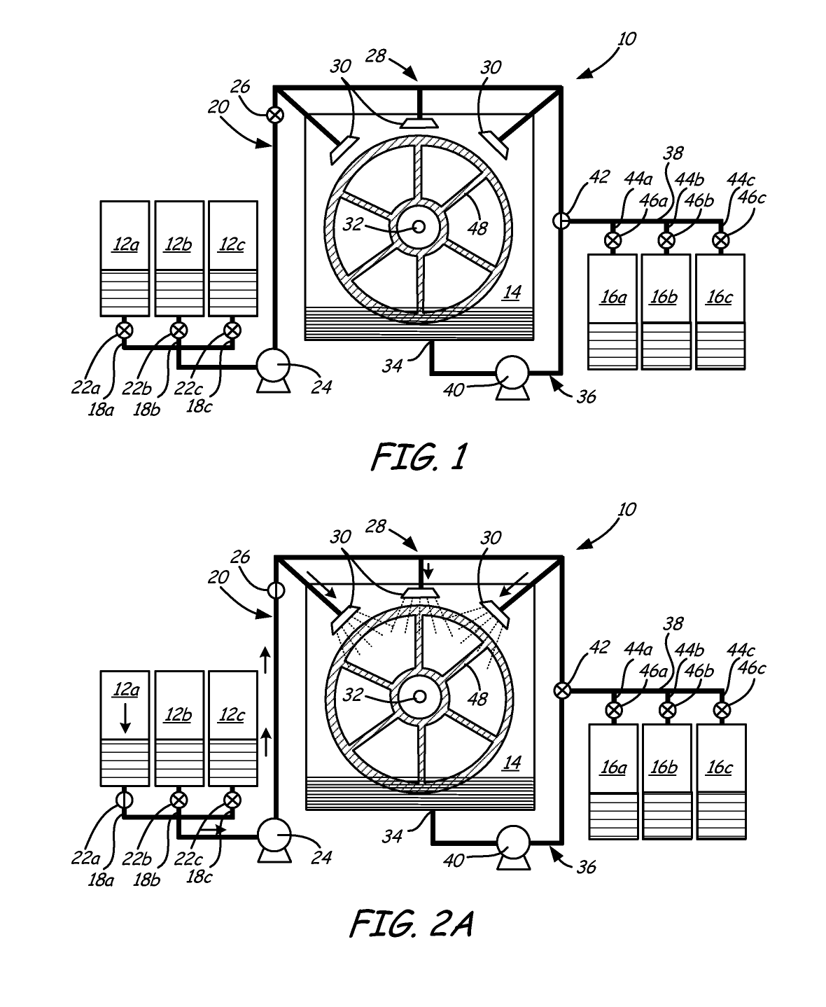

FIG. 1 illustrates one embodiment of a component recovery system for refurbishing components. Component recovery system 10 includes fluid feed tanks 12a-12c, refurbishment compartment 14, and waste tanks 16a-16c. Fluid feed lines 18a-18c connect the fluid feed tanks 12a-12c to fluid line 20. Each fluid feed line 18a-18c contains a valve 22. Fluid line 20 includes fluid delivery pump 24. Fluid delivery pump 24 delivers fluid from fluid feed tanks 12a-12c to fluid delivery line 28 and refurbishment compartment 14. Fluid line 20 also includes valve 26. Refurbishment compartment 14 may include multiple pieces to facilitate component insertion and removal.

Fluid feed tanks 12a-12c store the fluids used in the refurbishment process. Three fluid feed tanks 12a-12c are indicated in FIG. 1 for illustrative purposes. More or fewer fluid feed tanks may be present depending on the number of fluids needed for refurbishment. The fluids contain the chemicals used to refurbish the components in component recovery system 10. Examples of suitable fluids include strippers, solvents and rinse solutions. The fluids used in a component recovery system 10 will depend largely on the type of refurbishment to be performed (e.g., removing field contaminants, removing coatings, etc.). Suitable strippers include dichloromethane and other alkyl halides, aromatic hydrocarbons, kerosene and combinations thereof, such as Dynasolve 218, available from Dynaloy (Indianapolis, Ind.). Suitable solvents include kerosene, acetone and isopropanol. Suitable rinse solutions include acetone and water. One embodiment of component recovery system 10 may sequentially deliver an aromatic hydrocarbon/kerosene mixture, kerosene, acetone, and water to a component during refurbishment. Such an embodiment would require four fluid feed tanks 12.

Because aggressive solvents may be used in component recovery system 10, the system's tanks, lines, valves, and pumps must be constructed of materials that are resistant to aggressive solvents when used. Examples of suitable materials include stainless steel, Teflon, polyethylene and polypropylene.

Fluid feed lines 18a-18c allow fluid to flow from the fluid feed tanks 12a-12c, respectively, to refurbishment compartment 14 via feed line 20 and fluid delivery line 28. Each fluid feed line 18a-18c includes a valve 22a-22c configured to allow or prevent flow of the fluid in the feed tanks 12a-12c, respectively, into fluid line 20. Suitable valves 22a-22c include solenoid valves. Fluid line 20 allows fluid to flow from fluid feed lines 18a-18c to fluid delivery line 28 and refurbishment compartment 14. Fluid line 20 includes fluid delivery pump 24. Fluid delivery pump 24 is configured to pump fluid. Fluid enters fluid line 20 from fluid feed lines 18a-18c and is pumped through fluid line 20 towards fluid delivery line 28 by fluid delivery pump 24. Fluid line 20 also includes a valve 26 configured to allow or prevent flow of the fluid in fluid line 20 into fluid delivery line 28. Valve 26 may be a solenoid valve.

Fluid delivery line 28 connects fluid line 20 to refurbishment compartment 14. Fluid delivery line 28 provides one or more connections with refurbishment compartment 14. Fluid delivery line 28 may be plumbed directly into refurbishment compartment 14 or may connect to additional lines within refurbishment compartment 14. The embodiment illustrated in FIG. 1 shows three connections between fluid delivery line 28 and refurbishment compartment 14 (upper left corner, upper central area and upper right corner). More or fewer connections may be present depending on the design of refurbishment compartment 14. Fluid delivery line 28 supplies fluid to one or more delivery elements 30 located in the interior of refurbishment compartment 14. Delivery element 30 directs fluid to one or more components inside refurbishment compartment 14.

Delivery element 30 may be connected directly to fluid delivery line 28 within refurbishment compartment 14 or delivery element 30 may connect to fluid delivery line 28 via additional lines within refurbishment compartment 14. Delivery element 30 direct fluids to the component to be cleaned inside refurbishment compartment 14. Delivery element 30 is located within refurbishment compartment 14 and configured to direct fluid so that fluid may interact with the component surfaces. The embodiment illustrated in FIG. 1 shows three delivery elements 30 connected to the line in the upper left portion of refurbishment compartment 14, one delivery element in the upper central portion and three delivery elements in the upper right portion. Exemplary embodiments of component recovery system 10 may include delivery elements 30 positioned and configured to direct fluid optimally so that generally all component surfaces receive fluid. In some embodiments, delivery elements 30 may be adjustable so that optimal fluid delivery can be obtained during refurbishment for various components. Delivery elements 30 may include nozzles such as spray nozzles to atomize fluids or deliver fluids to a wide area within refurbishment compartment 14.

Components to be refurbished are placed within refurbishment compartment 14. FIG. 1 shows a ring strut ring 48 (component) within refurbishment compartment 14 for illustrative purposes. Other components that require refurbishment may be placed within refurbishment compartment 14. The dimension of refurbishment compartment 14 will vary depending on the size of the components to be refurbished. In an embodiment designed to refurbish a ring strut ring 48, refurbishment compartment 14 may have a length of about 4.5 feet (1.4 meters), a width of about 1 foot (0.3 meters), and a height of about 4.5 feet (1.4 meters). The interior dimensions and geometries of refurbishment compartment 14 may be modified to accommodate the shapes of the components to be refurbished as well as the position of delivery elements 30 and drain 34.

Refurbishment compartment 14 may include means for rotating or moving the components during refurbishment so that fluid directed by delivery element 30 contacts all component surfaces. One example of a rotating means is shaft 32, which may be motor driven. Components may be mounted or fastened to shaft 32 so that the component is rotated during the refurbishment operation. Rotation allows multiple component surfaces to come into contact with the fluids directed to the component by delivery element 30. In some embodiments, rotation may also allow component surfaces to submerge in fluid that has collected at the bottom of refurbishment compartment 14. Submerging the component provides additional contact between component surfaces and refurbishment fluids.

Refurbishment compartment 14 also includes a drain 34. Drain 34 is located in the lower portion of refurbishment compartment 14. Refurbishment compartment 14 may be designed to direct fluid towards drain 34. Drain 34 allows removal of fluid delivered to refurbishment compartment 14. Drain 34 may include a valve that can be closed to allow fluid to collect in the bottom portion of refurbishment compartment 14 to provide fluid in which the component may be submerged as described above. Drain 34 connects to recirculation line 36.

Recirculation line 36 connects refurbishment compartment drain 34 to fluid delivery line 28 and waste line 38. Recirculation line 36 includes recirculation pump 40. Recirculation pump 40 is configured to pump fluid. Recirculation pump 40 delivers fluid from drain 34 through recirculation line 36, fluid delivery line 28 and waste line 38. Recirculation line 36 also includes valve 42. Valve 42 allows or prevents the flow of fluid to fluid delivery line 28 or waste line 38 depending on the process step. During recirculation, valve 42 allows fluid to flow through recirculation line 36 to fluid delivery line 28 but not to waste line 38. During delivery to waste, valve 42 allows fluid to flow through recirculation line 36 to waste line 38 but not to fluid delivery line 28. To provide both recirculation and waste routes, valve 42 may be a three-way valve. Alternatively, two valves may be used. In one embodiment of the present invention, valve 42 may be a three-way solenoid valve.

Waste line 38 is connected to waste outlet lines 44a-44c. Waste outlet lines 44a-44c connect to waste tanks 16a-16c, respectively. Each waste tank 16a-16c has a separate waste outlet line 44a-44c. FIG. 1 illustrates one embodiment of a component recovery system 10 with three waste tanks 16a-16c. Waste outlet lines 44a-44c connect waste line 38 to waste tanks 16a-16c. Each waste outlet line 44a-44c contains a valve 46a-46c, respectively. Valves 46a-46c allow or prevent flow of the fluid from waste line 38 to each waste tank 16a-16c, respectively. Suitable valves 46a-46c include solenoid valves.

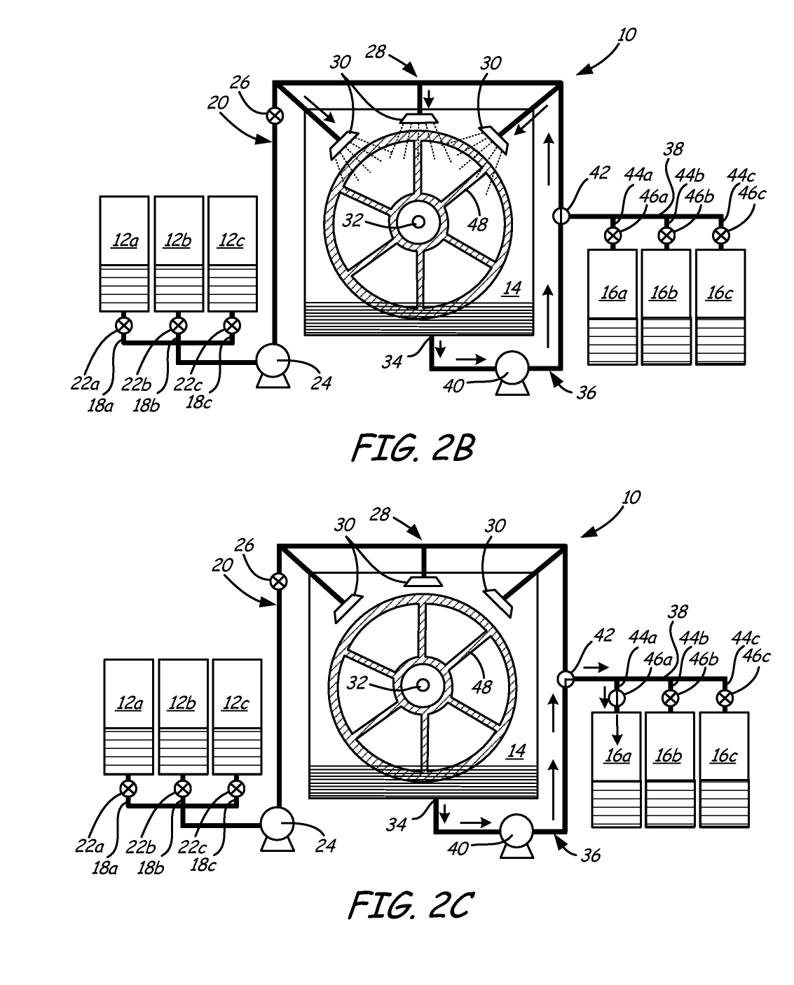

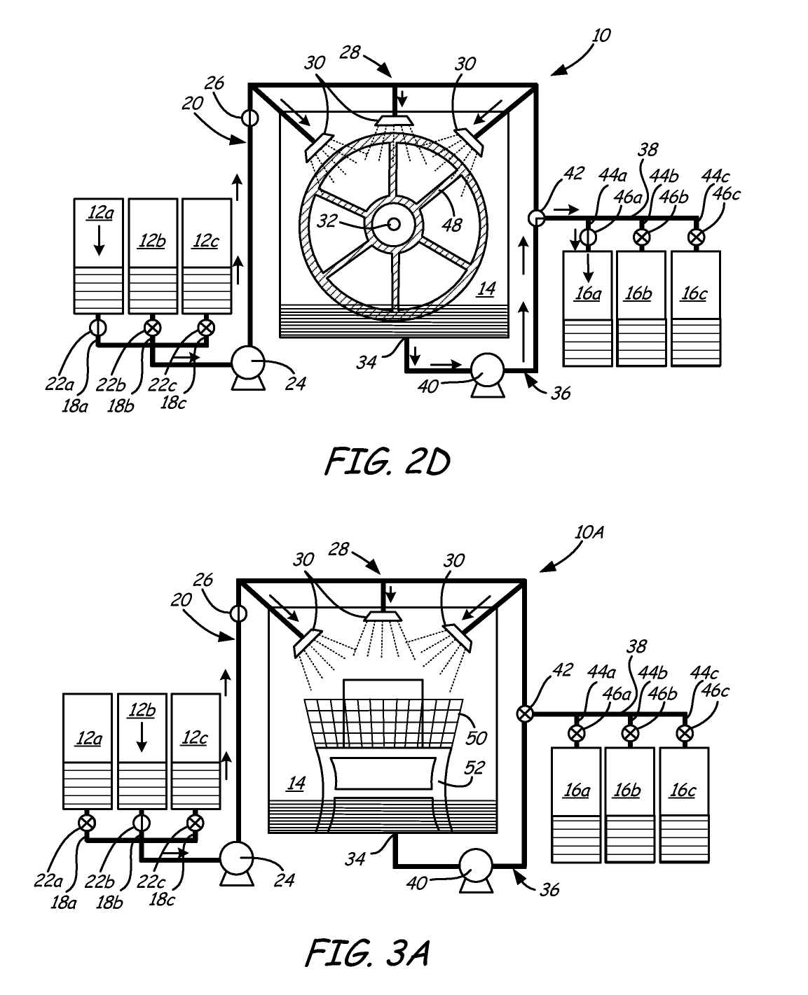

The various operative steps of refurbishment using one embodiment of component recovery system 10 are demonstrated in FIGS. 2A through 2D. In one such embodiment of the present invention, the refurbishment operation may be automated and controlled by one or more computers.

FIG. 2A illustrates component recovery system 10 in fill mode. Valve 22a is in the open position while valves 22b and 22c are in the closed position. Fluid from fluid feed tank 12a flows through valve 22a in fluid feed line 18a and into fluid line 20, while fluid from fluid feed tanks 12b and 12c are prevented from flowing through fluid feed lines 18b and 18c, respectively. Fluid delivery pump 24 pumps the fluid through fluid line 20. Valve 26 is in the open position and fluid flows through fluid line 20 to fluid delivery line 28. Valve 42 is in the closed position so that fluid entering fluid delivery line 28 does not flow through recirculation line 36 to waste line 38 or the bottom portion of refurbishment compartment 14. Fluid flows through fluid delivery line 28 to delivery elements 30. Delivery elements 30 direct the flow of fluid onto the surfaces of the component(s) located in refurbishment compartment 14, here ring strut ring 48. If it is attached to a shaft 32, the component may be rotated as fluid is directed towards its surfaces, thereby exposing as much of the components surface as possible to the fluid. As fluid flows into refurbishment compartment 14, drain 34 is in the closed position and fluid accumulates in the bottom portion of refurbishment compartment 14. Fluid accumulates in refurbishment compartment 14 until an adequate amount of fluid has been delivered to allow recirculation. In one embodiment, fluid may fill about ten percent of refurbishment compartment 14. In other embodiments, fluid may generally fill refurbishment compartment 14 until the entire component is submerged in fluid.

FIG. 2B illustrates component recovery system 10 in recirculation mode. Drain 34 is in the open position and allows fluid from refurbishment compartment 14 to empty and flow into recirculation line 36. Recirculation pump 40 is activated to pump fluid through recirculation line 36. Three-way valve 42 is opened so that fluid may flow from recirculation line 36 to fluid delivery line 28. Three-way valve 42 is configured to allow fluid to flow to fluid delivery line 28 while fluid is prevented from flowing to waste line 38 and waste tanks 16. Valve 26 is in the closed position. This prevents fluid from flowing back towards fluid line 20 and fluid feed tanks 12a-12c. Recirculated fluid thus flows from fluid delivery line 28 to delivery element 30 as described above in the fill mode operation. Fluid recirculates by flowing from drain 34 through recirculation line 36 and fluid delivery line 28 until it is once again directed toward the component in refurbishment compartment 14.

Recirculation mode may be employed for a predetermined amount of time. Depending on the fluid and its function, recirculation times may vary. Generally, fluid is recirculated until its function is completed or continued recirculation becomes suboptimal. For example, when the fluid delivered to refurbishment compartment 14 is a stripper, the fluid may be recirculated until it ceases to optimally strip coating from the component surfaces. A stripper ceases to function optimally once additional coating is no longer solubilized by the stripper or once the coating and bonding compounds are removed. Once the stripper is saturated with the coating stripped from the component surfaces, continued recirculation may be undesirable.

FIG. 2C illustrates component recovery system 10 in waste collection mode. Drain 34 is in the open position and allows fluid from refurbishment compartment 14 to empty and flow into recirculation line 36. Recirculation pump 40 is activated to pump fluid through recirculation line 36. Three-way valve 42 is opened so that fluid may flow from recirculation line 36 to waste line 38. Three-way valve 42 is configured to allow fluid to flow to waste line 38 while fluid is prevented from flowing to fluid delivery line 28. Valve 46a is in the open position and allows fluid to pass through waste outlet line 44a. Valves 46b and 46c are in the closed position to prevent fluid from entering waste tanks 16b and 16c, respectively. Waste fluid flows from recirculation line 36 to waste outlet line 44a and into waste tank 16a.

Waste fluid is collected and stored in waste tanks 16a-16c. Once a waste tank 16 is full, the contained waste fluid may be removed from waste tank 16 and prepared for disposal or reuse within component recovery system 10 or for other uses. In one embodiment, waste tanks 16a-16c may also serve as disposal tanks so that waste tanks 16a-16c may be removed from component recovery system 10, sent out for disposal, and new waste tanks 16a-16c may be added to component recovery system 10 to replace the tank sent for disposal.

In one embodiment of component recovery system 10, fluid waste collected in waste tanks 16a-16c may be reused by component recovery system 10. For example, waste stripper that is not saturated with the coating removed from the component(s) may be reused. Such waste fluid may be transferred to one of fluid feed tanks 12a-12c after it has been collected in one of waste tanks 16a-16c. Waste tanks 16a-16c and fluid feed tanks 12a-12c may be interchangeable so that waste tanks 16a-16c may be disconnected from waste outlet lines 44a-44c and connected to fluid feed lines 18a-18c for reuse.

FIG. 2D illustrates component recovery system 10 in rinse mode. Rinse mode provides for a single pass of fluid to the component(s) in refurbishment compartment 14. Valve 22a is in the open position while valves 22b and 22c are in the closed position. Fluid from fluid feed tank 12a flows through valve 22a in fluid feed line 18a and into fluid line 20, while fluid from fluid feed tanks 12b and 12c are prevented from flowing through fluid feed lines 18b and 18c, respectively. Fluid delivery pump 24 pumps the fluid through fluid line 20. Valve 26 is in the open position and fluid flows through fluid line 20 to fluid delivery line 28. Valve 42 is in a position so that fluid entering fluid delivery line 28 does not flow through recirculation line 36 to waste line 38 or the bottom portion of refurbishment compartment 14. Fluid flows through fluid delivery line 28 to delivery elements 30. Delivery elements 30 direct the flow of fluid onto the surfaces of the component(s) located in refurbishment compartment 14. Fluid flows into refurbishment compartment 14 at delivery elements 30 and exits through drain 34. Drain 34 is in the open position and allows fluid from refurbishment compartment 14 to empty and flow into recirculation line 36. Recirculation pump 40 is activated to pump fluid through recirculation line 36. Three-way valve 42 is positioned so that fluid may flow from recirculation line 36 to waste line 38. Valve 46a is in the open position and allows fluid to pass through waste outlet line 44a and into waste tank 16a. Valves 46b and 46c are in the closed position to prevent fluid from entering waste tanks 16b and 16c, respectively.

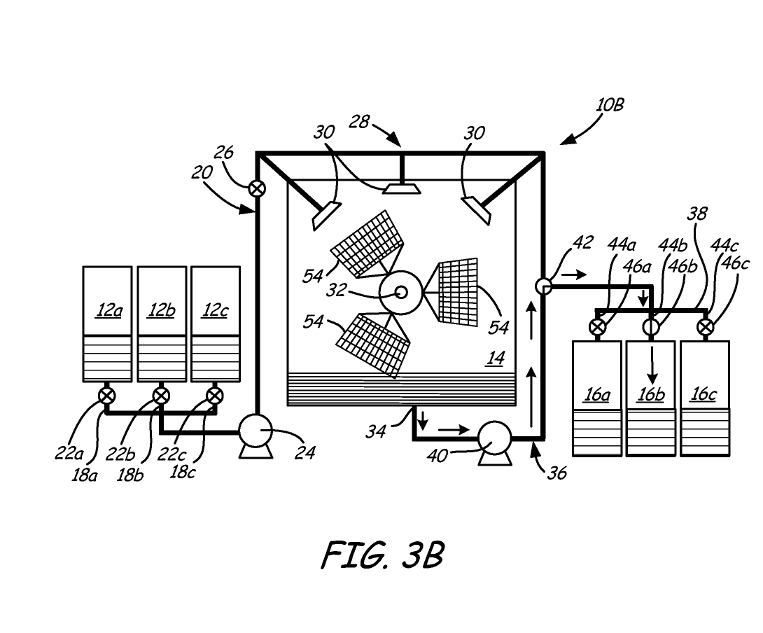

Alternative embodiments of component recovery system 10 may include one or more baskets 50 or cages 52 (illustrated in FIG. 3A and 3B, respectively) within refurbishment compartment 14. Basket 50 may be placed merely on the bottom inner surface of refurbishment compartment 14 or on a support 52 within refurbishment compartment 14. Basket 50 allows for multiple components to be easily inserted and removed from refurbishment compartment 14. Multiple baskets 50 arranged within refurbishment compartment 14 may provide for refurbishment of several components at once.

FIG. 3A illustrates component recovery system 10A in fill mode. Component recovery system 10A is generally similar to component recovery system 10, except that it includes basket 50 within refurbishment compartment 14. Basket 50 may hold components to be refurbished and position them so that fluid directed by delivery elements 30 comes in contact with component surfaces. Basket 50 may be a stainless steel basket with a plurality of openings to allow fluid to pass from the outside of the basket to the inside of the basket. Basket 50 may have an open side so that components may be easily positioned inside and removed from basket 50.

Alternatively, basket 50 may be replaced by cage 54, as illustrated in FIG. 3B. FIG. 3B illustrates component recovery system 10B in waste collection mode. Cage 54 may hold components to be refurbished and position them so that fluid directed by delivery elements 30 comes in contact with component surfaces during fill, recirculation and rinse modes. Additionally, cage 54 may be fastened to a shaft 32 and rotated. Cages 54 rotated on shaft 32 may provide multiple orientations of component surfaces with respect to delivery element 30. This may allow multiple component surfaces to come into contact with the fluids directed to the component by delivery element 30. Rotation may provide for increased fluid contact with component surfaces during refurbishment. As with baskets 50, multiple cages 54 may be arranged within refurbishment compartment 14. Multiple cages 54 may also be mounted or fastened to shaft 32. Cage 54 may be a stainless steel cage with a plurality of openings to allow fluid to pass from the outside of the cage to the inside of the cage.

The embodiments described above provide a system and method for component recovery with several advantages over the prior art. Refurbishment of a component can be performed while reducing the amounts of chemicals needed. A smaller amount of chemicals translates to cost savings in the purchasing and disposal of the chemicals. The process can be automated to reduce workers' exposure to harsh or toxic chemicals. Embodiments of the component recovery system may also reduce space requirements needed for refurbishment.

Although the present invention has been described with reference to exemplary embodiments, workers skilled in the art will recognize that changes may be made in form and detail without departing from the spirit and scope of the invention.

1. A refurbishment system comprising:
at least one feed tank;
a refurbishment compartment;
at least one fluid delivery element housed within the refurbishment compartment and connected to the at least one feed tank by a first fluid line; and
at least one waste tank connected to the refurbishment compartment by a second fluid line.

2. The system of claim 1, wherein the at least one feed tank contains a fluid selected from the group consisting of strippers, solvents, rinse solutions and combinations thereof.

3. The system of claim 1 further comprising:
a first pump for delivering fluid through the first fluid line; and
a second pump for delivering fluid through the second fluid line.

4. The system of claim 1, wherein the refurbishment compartment further comprises means for rotating a component within the refurbishment compartment.

5. The system of claim 1, wherein the refurbishment compartment further comprises at least one basket.

6. The system of claim 1, wherein the refurbishment compartment further comprises:
at least one cage; and
means for rotating the at least one cage within the refurbishment compartment.

7. The system of claim 1, wherein the at least one fluid delivery element is a spray nozzle.

8. The system of claim 1, wherein the first and second fluid lines further comprise a plurality of valves configured to prevent or allow fluid flow through the first and second fluid lines.

9. The system of claim 8, wherein the plurality of valves are solenoid valves.

10. A method for refurbishing a component, the method comprising:
placing a component containing a coating in a refurbishment compartment;
delivering a first fluid to the refurbishment compartment, wherein the first fluid removes contaminants, coatings or bonding compounds from the component;
removing the first fluid from the refurbishment compartment and delivering the first fluid to a first waste tank;
delivering a second fluid to the refurbishment compartment, wherein the second fluid removes contaminants, coatings, bonding compounds or traces of the first fluid from the component; and
removing the second fluid from the refurbishment compartment and delivering the second fluid to a second waste tank.

11. The method of claim 10 further comprising recirculating the first fluid through the refurbishment compartment.

12. The method of claim 11, wherein recirculating the first fluid through the refurbishment compartment comprises:
removing the first fluid from the refurbishment compartment; and
redelivering the first fluid to the refurbishment compartment.

13. The method of claim 10 further comprising recirculating the second fluid through the refurbishment compartment.

14. The method of claim 10 further comprising rotating the component in the refurbishment compartment.

15. The method of claim 10 further comprising reusing the second fluid delivered to the second waste tank.

16. A refurbishment system comprising:
at least one fluid feed tank;
a refurbishment compartment comprising:
at least one fluid delivery element; and
a drain;
a fluid line connecting the at least one fluid feed tank to the at least one fluid delivery element;
a feed pump configured to deliver fluid through the fluid line;
at least one waste tank;
a recirculation line connecting the refurbishment compartment drain to the at least one fluid delivery element and to the at least one waste tank; and
a recirculation pump configured to deliver fluid through the recirculation line.

17. The refurbishment system of claim 16, wherein the refurbishment compartment further comprises means for rotating a component within the refurbishment compartment.

18. The refurbishment system of claim 16, wherein the refurbishment compartment further comprises at least one basket.

19. The refurbishment system of claim 16, wherein the at least one fluid delivery element is a spray nozzle.

20. The refurbishment system of claim 19, wherein the at least one spray nozzle is positioned in an upper portion of the refurbishment compartment.

21. The refurbishment system of claim 16, wherein the fluid and recirculation lines further comprise solenoid valves configured to prevent or allow fluid flow through the fluid and recirculation lines.

22. The refurbishment system of claim 21, wherein the recirculation line solenoid valve is a three-way solenoid valve.
